(19) United States
(12) Patent Application Publication
(10) Pub. No.: US 2021/0319276 A1
(43) Pub. Date: Oct. 14, 2021

(54) Temperature-Sensing RFID Tag

(71) Applicant: Brady Worldwide, Inc., Milwaukee, WI (US)

(72) Inventors: Gregg J. Haensgen, Menomonee Falls, WI (US); Jacob C. Jozefiak, Valencia, CA (US); Scott M. Bellon, West Bend, WI (US); Nicholas Krogman, Hubertus, WI (US)

(21) Appl. No.: 17/270,363

(22) PCT Filed: Aug. 22, 2019
(86) PCT No.: PCT/US2019/047730

§ 371 Date: Feb. 22, 2021

Related U.S. Application Data
(60) Provisional application No. 62/724,160, filed on Aug. 29, 2018.

(51) Int. Cl. G06K 19/07; G06K 19/077; G06K 19/02

(52) U.S. Cl. CPC G06K 19/0717; H01Q 1/2216; G06K 19/025; G06K 19/07722

(57) ABSTRACT

A radio frequency identification (RFID) tag designed for sensing a temperature includes a flag section and a tail section. The flag section including an integrated circuit with an RFID transponder and a temperature sensor in communication with the RFID transponder, and the tail section projects outwardly from the flag section to an outward end of the tail section. A thermally-conductive material is coupled to the tail section and is configured to transfer thermal energy from the outward end of the tail section to the temperature sensor.

### CROSS-REFERENCE TO RELATED APPLICATION

This application claims the benefit of the filing date of U.S. Provisional Application No. 62/724,160 entitled “Temperature-Sensing RFID Tag” filed on Aug. 29, 2018, which is hereby incorporated by reference for all purposes as if set forth in its entirety herein

### TECHNICAL FIELD

This application relates to radio frequency identification devices and, in particular, radio frequency identification devices for communicating temperature data.

### BACKGROUND

Radio frequency identification (“RFID”) uses electromagnetic fields and radio frequency (“RF”) signals to wirelessly communicate between an RFID reader (e.g., a local interrogator) and RFID transponder (e.g., a tag). RFID systems can be used for a wide array of purposes, such as inventory management and tracking, access control, or wireless data communication.

A typical RFID transponder includes an integrated circuit (“IC”) for storing information and an antenna for sending and receiving signals from the RFID reader and is either active or passive. Active RFID systems include a power source such as a battery for powering the IC and antenna. However, in passive RFID systems, the RFID transponder does not include a power source; instead, the transponder harnesses energy from an interrogation signal sent by the RFID reader and received by the antenna and then utilizes that energy to identify itself or other information associated with the transponder.

SUMMARY

In some applications RFID tags have been implemented as wireless sensors for detecting and communicating various parameters about an object to which the RFID tag is connected. In some applications, a temperature sensor can be implemented in a wireless RFID tag. In other applications, however, a variety of alternative sensor types can be used.

However, when in close proximity to energy absorbing or conductive materials such as (e.g., conductive metals), RFID tags, especially passive RFID tags operating in ultra-high frequency (UHF) band, suffer from reduced transmission ranges.

Disclosed herein are various improved structures for supporting RFID tags which are attachable to surfaces to provide information about the surface (e.g., temperature information). This can be achieved by implementing an RFID tag having a flag section with an RFID transponder and temperature sensor and a tail section integrally-formed with the flag section. The tail section is configured to support the flag section such that the flag section protrudes away from the object to which the RFID tag is attached. The separation created by the tail section significantly reduces or eliminates any signal loss due to the presence of an adjacent signal-absorbing body, thereby increasing the transmission range. A slim form-factor of the tag can enable easy use of a wide range of RFID printers for printing and/or encoding on said RFID tag.

According to one aspect, a radio frequency identification (RFID) tag for sensing a temperature of a surface is disclosed. The RFID tag includes a flag section and a tail section. The flag section includes an integrated circuit including an RFID transponder and a temperature sensor in communication therewith. The tail section projects outwardly from the flag section to an outward end. A thermally-conductive material is coupled to the tail section and configured to transfer thermal energy from the outward end of the tail section to the temperature sensor in the integrated circuit in the flag section.

According to another aspect, a strip of radio frequency identification (RFID) temperature sensor system can include a plurality of RFID tags integrally formed in a continuous sheet that are detachable from one another to provide individual RFID tags.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE FIGURES

FIG. 1a is a top-down plan view of a temperature-sensing RFID tag in an unfolded position.

FIG. 1b is a cross-sectional schematic of the RFID tag of FIG. 1a.

FIG. 2a is a top-down plan view of the RFID tag of FIG. 1a with the flag portion in the folded position.

FIG. 2b is a cross-sectional schematic of the RFID tag of FIG. 2a.

FIG. 3 is a cross-sectional schematic of the RFID tag of FIG. 2a secured to a metal object.

FIG. 4a is a top-down plan view of a continuous sheet of temperature-sensing RFID tags.

FIG. 4b is a cross-sectional schematic of the continuous sheet of temperature-sensing RFID tags of FIG. 4a.

FIG. 5 is a top-down plan view of a temperature-sensing RFID tag without a folding section.

FIG. 6a is a top-down plan view of another type of temperature-sensing RFID tag with a folding tail in the unfolded position.

FIG. 6b is a top-down plan view of the RFID tag of FIG. 6a in the folded position in which the tail portion has been folded over onto the flag portion.

FIG. 7a is a cross-sectional schematic of the RFID tag of FIG. 6a in the unfolded configuration.

FIG. 7b is a cross-sectional schematic of the RFID tag of FIG. 6b in the folded configuration.

FIG. 8 is a layered schematic of the stacked layers in a temperature-sensing RFID tag in an unattached configuration with the liner covering the adhesive.

FIG. 9 is the layered schematic of the RFID tag of FIG. 8 secured to a metal object after the liner has been removed.

FIGS. 10-13 are charts showing test results for embodiments of the RFID tag of FIGS. 1a-3 with different thermally-conductive materials.

FIG. 14 is a chart of test result data for embodiments of the RFID tag of FIGS. 8-9 with different thermally-conductive materials.

### DETAILED DESCRIPTION

Embodiments of the disclosure may be further understood with reference to the figures. The drawings are not necessarily to scale, especially the stacked layer views in which thicknesses are exaggerated so they are more easily seen.

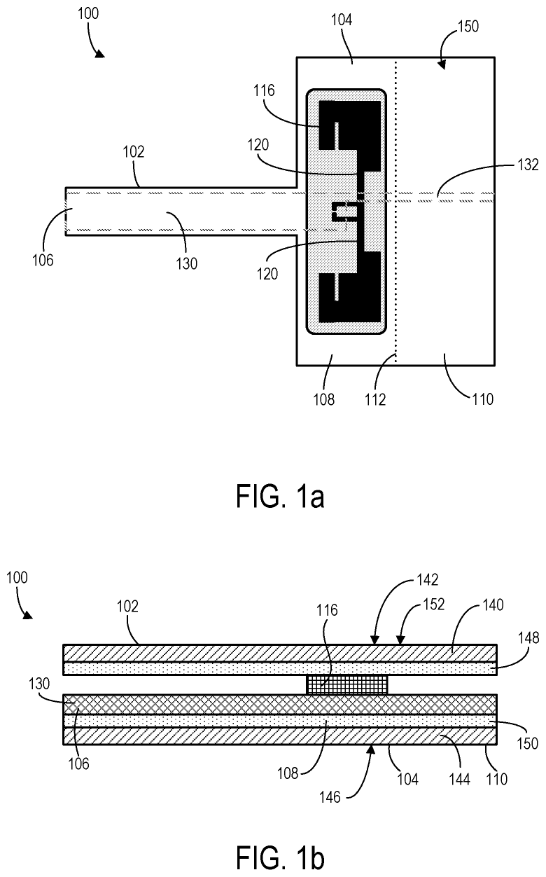

FIGS. 1a and 1b illustrate an exemplary embodiment of an RFID tag 100 configured to sense the temperature of an object to which the RFID tag 100 is attached. The RFID tag 100 includes a tail section 102 and a flag section 104 which are generally coplanar with each other and, as shown in FIGS. 1a and 1b, in an unfolded position or configuration. The tail section 102 projects outwardly away from the flag section 104 and extends to an outward end 106 opposite the flag section 104. In the particular embodiment illustrated, the flag section 104 includes two subsections: (1) an inlay section 108 from which the tail section 102 projects, and (2) a fold-over section 110 joined with the inlay section 108 opposite the tail section 102 along fold line 112.

In the illustrated embodiment, the inlay section 108 includes an integrated circuit (IC)/temperature sensor 116 centrally positioned between the tail section 102 and the fold-over section 110. The IC includes the temperature sensor that is in communication with an RFID transponder configured to wirelessly communicate with an RFID reader (not shown). In the illustrated embodiment, the RFID transponder includes two antenna arms 120 which extend laterally outward.

It is contemplated that, in other embodiments, an IC with an alternative configuration could be used. For example, some embodiments can include additional electrical components integrated in, or connected to, the IC. Further, the IC can be peripherally positioned within the inlay section 108, or positioned in the tail section 102, the fold-over section 110, or in any other portion of the RFID tag 100.

The RFID tag 100 further includes a thermally-conductive material 130 that extends longitudinally from the outward end 106 of the tail section 102 to a side of the fold-over section 110 opposite the outward end 106. The thermally-conductive material 130 crosses the IC 116 so that a portion of the thermally-conductive material 130 is in vertical alignment with the temperature sensor. In the illustrated embodiment the thermally-conductive material 130 is in contact with the IC/temperature sensor 116. The thermally-conductive material 130 includes a notched portion 132 with a reduced lateral width so that the thermally-conductive material 130 only overlaps one of the two antenna arms 120.

Looking to FIG. 1b, further structural details of the exemplary RFID tag 100 are illustrated. The tail section 102 and the flag section 104 include a top layer 140 (typically a printable paper layer) which provides an upper surface 142 and a bottom layer 144 (typically a release liner) which provides a lower surface 146. The thermally-conductive material 130 is positioned between the top layer 140 and the bottom layer 144, and is secured thereto by two layers of adhesive 148, 150 disposed therebetween. The IC 116 is positioned between the thermally-conductive material 130 and the top layer 140 and is secured to the top layer 140 with the top layer of adhesive 148. It is noted that, while the adhesive 148 is not illustrated as being in contact with the thermally-conductive material 130, the adhesive 148 will in fact be in contact with the thermally-conductive material 130, except for where the IC 116 is situated. For portions of the tail section 102 and the flag section 104 which do not include a portion of the thermally-conductive material 130 positioned between the top and bottom layers, 140, 144 (including portions of the flag section 104 that correspond to the notched portion 132 of the thermally-conductive material 130), the top layer 140 can be coupled to the bottom layer 144 directly or via adhesives or other joining modes (not shown).

In some embodiments an additional layer of adhesive may be included between the IC 116 and the thermally-conductive material 130, or between the IC 116 and the top layer 140. Still yet, other modes of connection between the layers are contemplated, both adhesive and non-adhesive, as well as other structural arrangements.

With continued reference to FIGS. 1a and 1b, the top layer 140 is formed from a material which can be printed on, thereby providing a printable surface 152 on the upper surface 142 of the flag section 104. The printable surface 152 is configured so that a printer can dispose information on the upper surface 142 of the inlay section 108 and the fold-over section 110. In other embodiments, it is contemplated that the upper surface 142 of the tail section 102 can also include a printable surface 152 on which information can be printed.

Further, in the illustrated embodiment, the bottom layer 144 is a removable liner which is selectively secured to the thermally-conductive material 130 and can be peeled off of the RFID tag 100 to expose the bottom layer of adhesive 150. Once exposed, the bottom layer of adhesive 150 can be used to couple the RFID tag 100 to other materials or surfaces, or to couple other objects to the RFID tag 100.

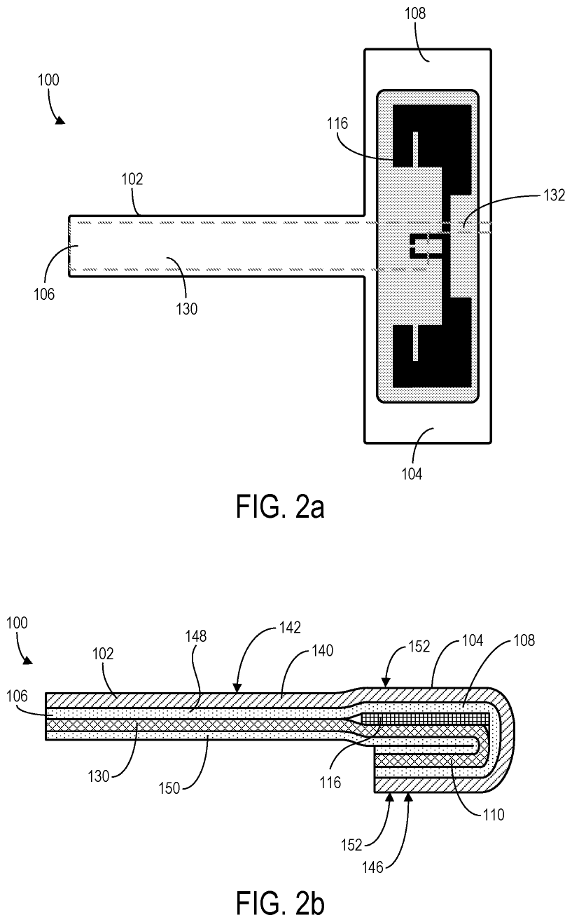

Referring now to FIGS. 2a and 2b, the top layer 140, the bottom layer 144, and the thermally-conductive material 130 are made from a flexible material, thereby helping to enable the tail section 102 and the flag section 104 to flex without breaking to accommodate the illustrated fold. Amongst other factors, the flexibility of the top and bottom layers 140, 144 help to enable the fold-over section 110 to be folded such that the fold-over section 110 pivots relative to the inlay section 108 about fold line 112 (from FIGS. 1a and 1b) and moves under the inlay section 108, thereby creating the folded position or configuration of the RFID tag 100 illustrated in FIGS. 2a and 2b. The section of the notched portion 132 of the thermally-conductive material 130 within the fold-over section is configured so that, in the folded position, it is substantially in vertical alignment with the section of the notched portion 132 retained within the inlay section 108.

By removing the bottom layer 144 from the RFID tag 100 prior to folding, the bottom layer of adhesive 150 can secure the fold-over section 110 to the inlay section 108, as shown in FIG. 2b. In this way, information may be printed only on one side of the flag section 104, but displayed on the upper surface 142 and the lower surface 146 thereof after being folded.

In other embodiments, it is contemplated that an RFID transponder could be coupled to the upper surface or the lower surface of the inlay section rather than inside the flag between layers. The RFID transponder could also be coupled directly to the flag or positioned within an inlay formed in the flag section. Accordingly, the tail section and/or the flag section can be formed from a single layer of material or more that two layers of material in alternative embodiment. Still further, it is contemplated that in multilayer structures, the layers might be joined in other non-adhesive ways (for example, by heating the layers to form a connection between the layers).

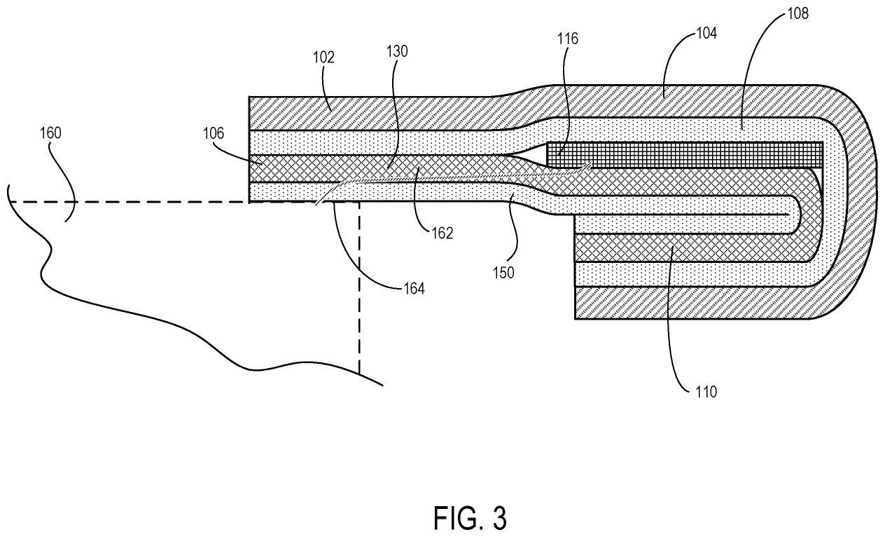

Looking now to FIG. 3, the RFID tag 100 is illustrated in use with a metal object 160 to sense the temperature thereof. The outward end 106 of the tail section 102 is secured to the metal object 160 by the bottom layer of adhesive 150. The tail section 102 is configured to support the flag section 104 and hold it apart from that the metal object 160, thereby creating a spatial separation between the RFID transponder of the flag section 104 and the metal object 160. In the illustrated embodiment, the tail section 102 and the flag section 104 project linearly away from the metal object 160 such that the tail section 102 and the flag section 104 are generally parallel to the surface of said metal object 160. In other embodiments, however, the tail section 102 and the flag section 104 can be configured to from the metal object 160 at an angle and non-linearly (i.e. so that the RFID tag 100 is curved).

The tail section 102 is further configured so that the distance between the RFID transponder in the flag section 104 and the metal object 160 is at least great enough to reduce the signal loss in which the RFID transponder is subjected to due to the proximity of the metal object 160. The distance between the RFID transponder and the metal object 160 can be a function of at least one of (1) the angle at which the tail section 102 projects away from the metal object 160, (2) the length of the tail section 102, and/or (3) the orientation and position of the RFID transponder.

In some embodiments, the separation between the RFID transponder and the metal object 160 may be greater than a minimum distance needed to eliminate the signal loss the RFID transponder is subjected to due to the properties of said nearby metal object 160. The magnitude of the minimum distance can vary as a function of at least one of the properties of the signal loss-causing object, properties of the tail section 102, the flag section 104, the thermally-conductive material 130, and specifications the RFID transponder itself.

In the configuration illustrated in FIG. 3, thermal energy is transferred from the metal object 160, through the tail section 102 and the flag section 104, to the IC/temperature sensor 116 by way of conductive heat transfer generally along thermal path 162. Thermal energy moving along thermal path 162 moves from the metal object 160 into the bottom layer of adhesive 150, propagating radially outward from the point of contact between the metal object 160 and the RFID tag 100. The thermal energy is then transferred through the bottom layer of adhesive 150 into the thermally-conductive layer 130, which provides a medium through which the thermal energy can be transfer to the IC/temperature sensor 116 within the inlay section 108. The adhesive can be selected such that it has good thermal conductivity in the z-axis (that is, the direction perpendicular to the plane of extension of the various layers). However, a non-thermal conductive adhesive could be used as well.

The thermal path 162 illustrated in FIG. 3—in which the tag 100 is very much not to scale—is a representative thermal pathway between one point on the surface of the metal object 160 and the IC/temperature sensor. Thermal energy is conducted from the metal object 160 into the RFID tag 100 over the entire area of the interface between the surface of the metal object 160 and the bottom layer of adhesive 150. As such, additional thermal paths (not shown), similar to thermal path 162, originate from points along the interface between the surface of the metal object 160 and the bottom layer of adhesive 150. In other embodiments, it is contemplated that thermal energy may be transferred from the metal object 160 to the IC/temperature sensor 116 along other pathways with alternative profiles. It is further contemplated that other embodiments can transferred to the IC/temperature sensor 116 through convective or radiative heat transfer, or through any combination of convection, conduction, or radiation.

In the illustrated embodiment, the thermally-conductive material 130 of the RFID tag 100 is formed from graphite and has a greater thermal conductivity in the lateral and longitudinal directions than in the vertical direction (i.e., the direction perpendicular to the direction of extension of the various layers). This elevated longitudinal thermal conductivity enables, in part, the rapid transfer of thermal energy along the length of the tail section 102 and flag section 104 and to the IC/temperature sensor 116, thereby increasing the responsiveness of the temperature sensor to temperature changes of the metal object 160 as well as the accuracy. Further, the elevated longitudinal thermal conductivity of the thermally-conductive layer 130 can enable increased tail section 102 lengths so that the signal loss the RFID transponder is subjected to due to the proximity of the metal object 160 being reduced (i.e., the flag portion can be positioned further from the object).

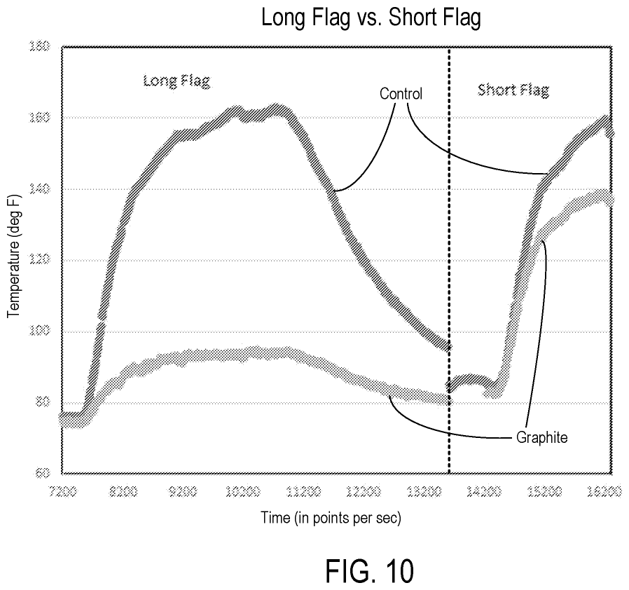

Looking forward to FIG. 10, test results for two embodiments of an RFID tag with a graphite thermally-conductive layer, one having a long tail section (labeled “long flag” in the figures) and one having a short tail section (labeled “short flag” in the figures), are illustrated. In the test, the temperature of a metal object was detected by each of the RFID tags and transmitted to an RFID receiver. Temperatures received by the RFID receiver were compared to a direct temperature measurement of the metal object (referred to as the “control” across the various figures with comparative data).

As shown by the recorded data, the length of the tail section can be correlated to the temperature detected by the temperature sensor. Specifically, the difference between the temperature detected by the temperature sensor and the temperature recorded at the surface of the metal object was greater for the RFID tag having a long tail section than it was for the RFID tag having a short tail section. In some embodiments, this systematic error can be compensated for with analytical processes that adjust the detected temperatures based, at least in part, on the length of a particular tail section. It is further contemplated that the difference between the temperature detected by the temperature sensor and the true temperature of the metal object can be compensated for with other features or methods (e.g., software interpretation).

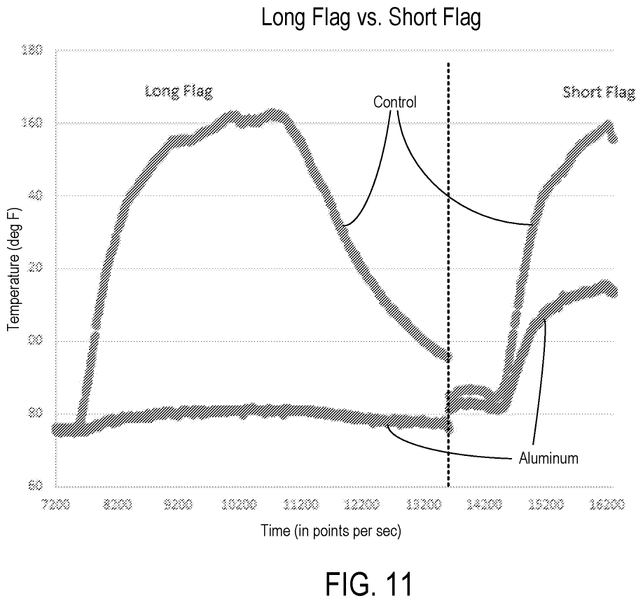

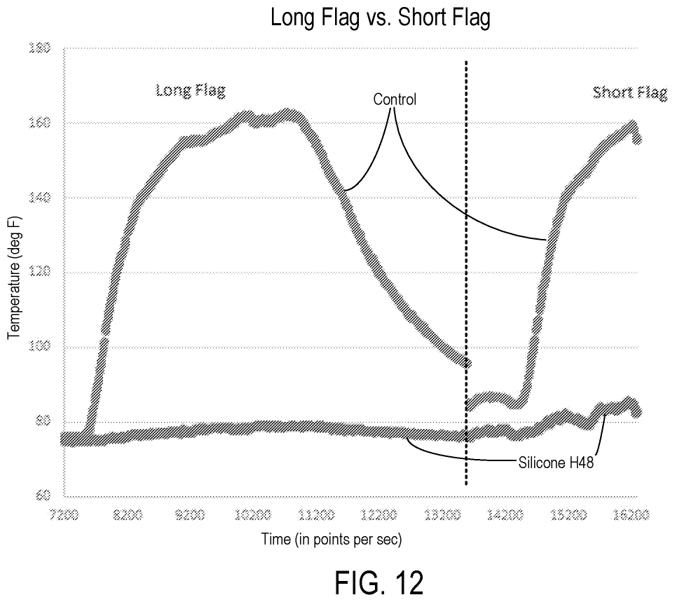

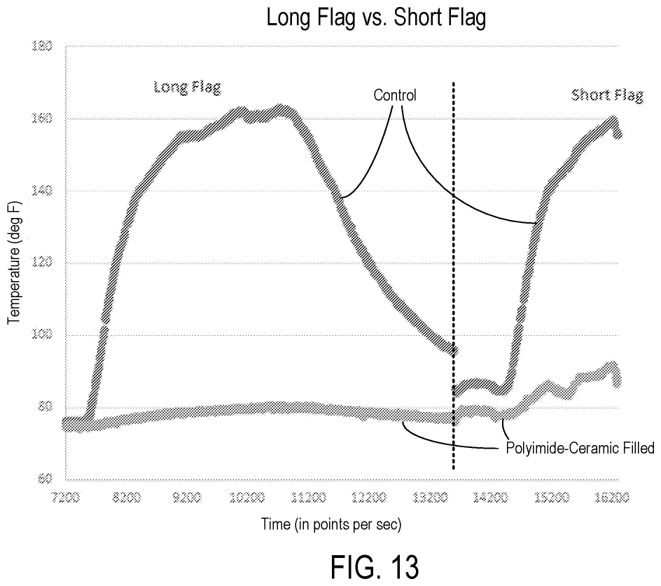

In other embodiments, it is contemplated that alternative materials, including aluminum, graphene, silicone, ceramic-filled polyimide, or other materials with thermally-conductive properties can be used as the thermally-conductive material 130. Similarly to the tests with the RFID tag 100 having a graphite thermally-conductive layer 130, temperature-sensing RFID tags having aluminum, silicone, and ceramic-filled polyimide thermally-conductive layers were tested. The results of each of these tests are illustrated in FIGS. 11, 12, and 13, respectively.

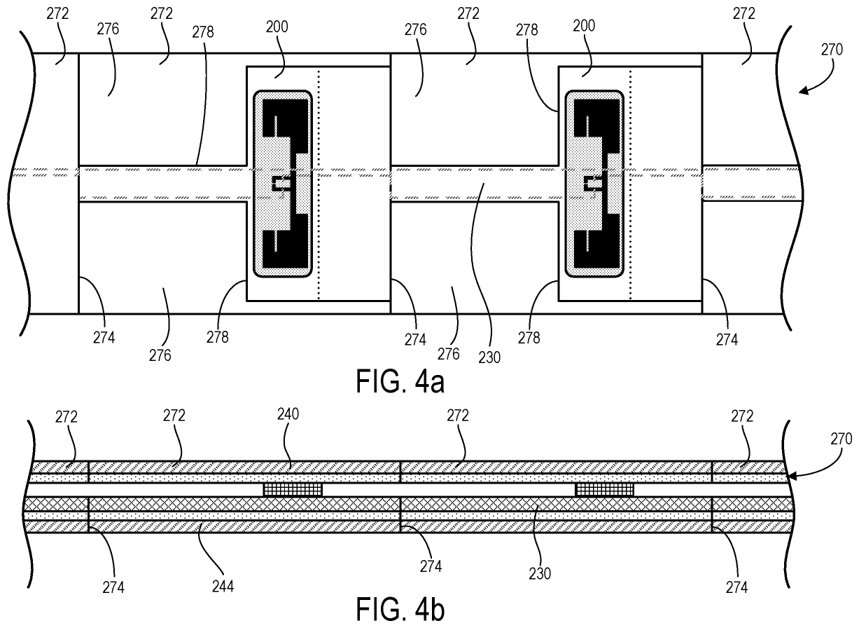

Returning now to FIGS. 4a and 4b, an embodiment of an RFID tag 200 configured to be printed on and encoded in a roll-to-roll manner is illustrated on a continuous roll. A continuous sheet 270 includes a plurality of temperature sensitive RFID tags 200 integrally formed in the continuous sheet 270. Each RFID tag 200 is positioned within a detachable section 272 that is detachably joined to each adjacent detachable section 272 at a separation line 274. The continuous sheet 270 is flexible and has a form factor sufficiently thin such that the continuous sheet 270 can be used with an RFID printer and/or RFID encoder configured for roll-to-roll printing and/or encoding. This allows for the rapid printing and encoding of each RFID tag 200 in the continuous roll.

Each detachable section 272 is configured to be separated from the continuous sheet 270 at separation lines 274, which can be perforated for easy separation of the tags from one another. Similarly, in some embodiments, each RFID tag 200 can be separated from the additional sheet material 276 at separation lines 278. In this way each RFID tag 200 can be used individually.

In another embodiment, it is contemplated that separation lines 274 may not be perforated and a different method can be used to ease separation of each detachable sheet, including alternative modifications to the continuous sheet 270 or use of cutting mechanisms or methods (such as die cutting). The separation lines 278 around each RFID tag 200 may similarly vary. Further, it is contemplated that the additional sheet material 276 can be remain attached to the RFID tag 200 without.

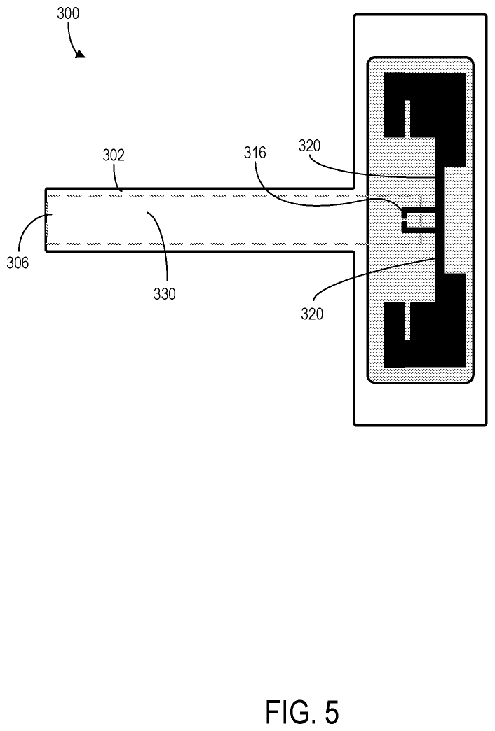

Looking now to FIG. 5, an embodiment of an RFID tag 300 configured to detect temperature that does not include a fold-over section is illustrated. In this embodiment, the thermally-conductive material 330 extends from the outward end 306 of the tail section 302 to an IC/temperature sensor 316 in a flag section 304. The thermally-conductive material 330 does not cross either of the two antenna arms 320.

The RFID tag 300 is formed from layered materials, similar to the construction illustrated with respect embodiments illustrated in FIGS. 1-3. The RFID tag 300 can be manufactured individually or formed in a sheet including additional RFID tags (not shown). Each RFID tag 300 can be separated from such a sheet at least though any methods described in connection with the embodiments illustrated in FIGS. 4a and 4b.

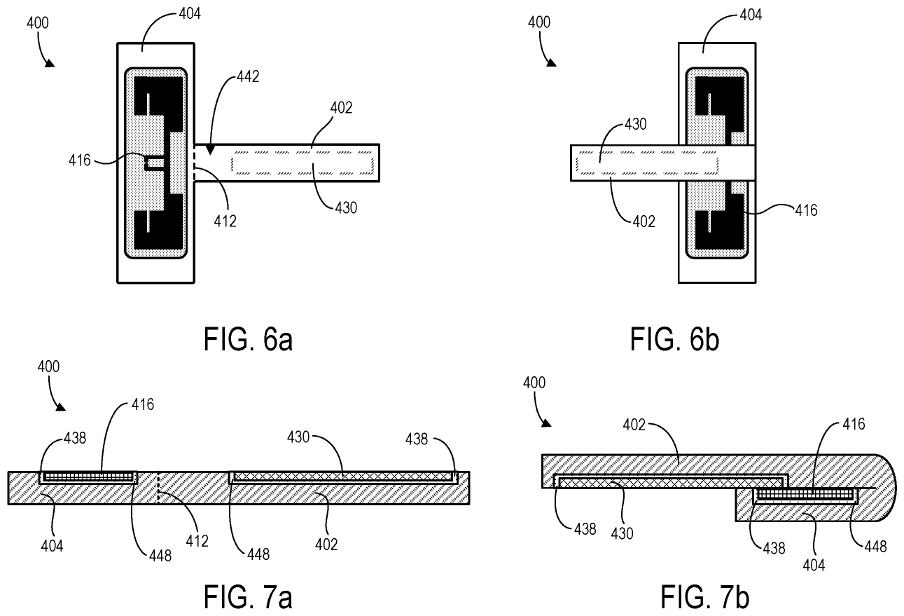

Referring now to FIGS. 6a, 6b 7a, and 7b, yet another embodiment of a temperature sensitive RFID tag 400 is illustrated. The RFID tag 400 includes a foldable tail section 402 including a thermally-conductive material 430, and a flag section including an IC/temperature sensor 416. The IC/temperature sensor 416 and the thermally-conductive material 430 are disposed in an inlay 438 formed in the upper surface 442 of the flag section 404 and tail section 402, respectively, and are secured thereto with and adhesive 448. It is contemplated that, in other embodiments, the thermally-conductive material 430 and/or the IC/temperature sensor 416 can be disposed directly on the upper surface 442. Still further, the thermally-conductive material 430 and/or the IC/temperature sensor 416 might be laminated aluminum, copper, or graphene on PET or it could be printed conductive ink.

The tail section 402 can be folded on fold line 412 from a planar unfolded position (FIGS. 6a and 7a) to a folded position (FIGS. 6b and 7b) where the thermally-conductive material 430 is in contact with the IC/temperature sensor 416. Similar to the embodiments of FIGS. 1a-5, the RFID tag 400 can be produced individually or in a sheet with additional RFID tags 400.

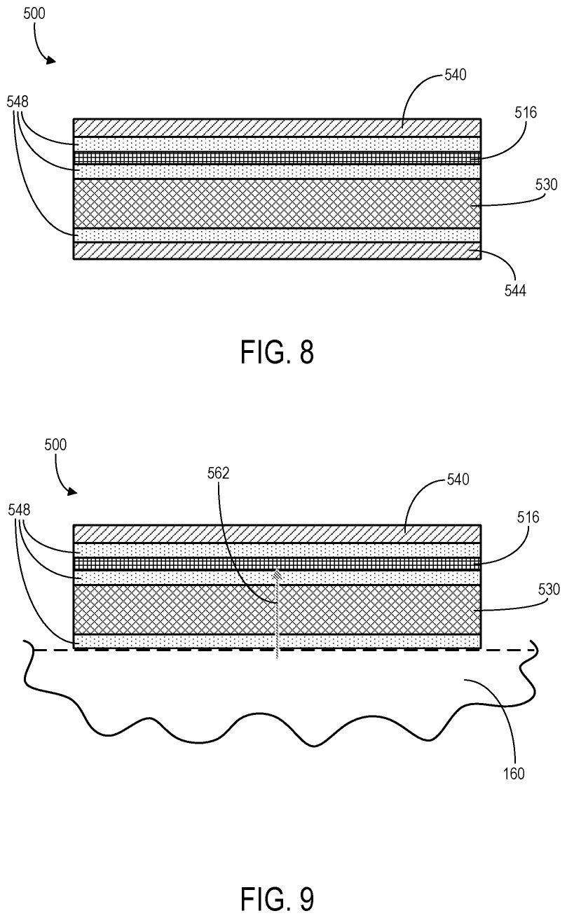

Looking now to FIGS. 8 and 9, yet another embodiment of an RFID tag 500 is illustrated in which the tag has a stacked thermally conductive spacer design without a tail. The RFID tag 500 includes a plurality of layers stacked vertically upon each other with a plurality of adhesive layers 548 to secure each layer or component to adjacent layers or components. In particular, a thermally-conductive material 530 and an IC/temperature sensor 516 are retained between a top layer 540 and a bottom layer 544, with the IC/temperature sensor 516 positioned vertically above the thermally-conductive material 530.

In the illustrated embodiment, the thermally-conductive material 530 is formed from silicone and has a greater thermal conductivity in the vertical direction than in the lateral and longitudinal directions. Looking specifically to FIG. 9, the RFID tag 500 can be coupled directly to a metal object 160 and thermal energy is conducted vertically along thermal path 562 (or a similar thermal path). Here, the thermally-conductive layer 530 has a thickness sized so that the distance between the RFID transponder in the IC/temperature sensor 516 and the metal object 160 is at least great enough to reduce the signal loss the RFID transponder is subjected to due to the proximity of the metal object 160.

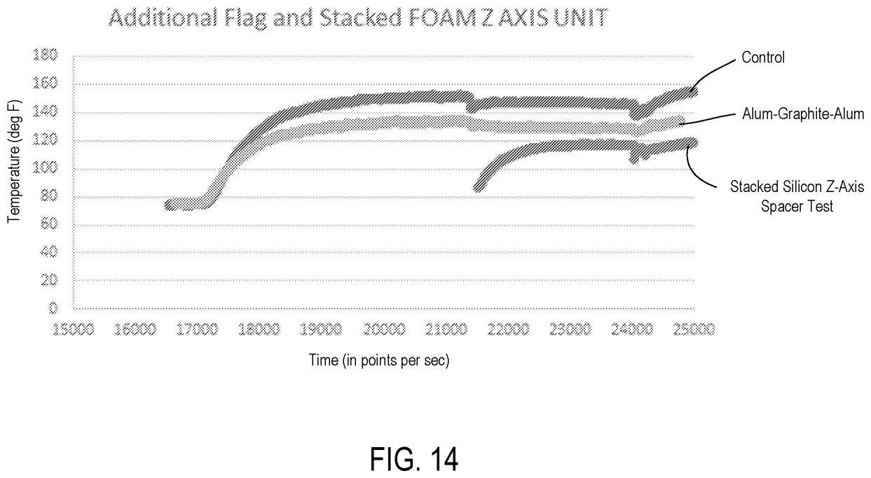

FIG. 14 is a chart of test result data for embodiments of the RFID tag of FIGS. 8-9 with different thermally-conductive materials to illustrate their comparative performances.

In some embodiments, it is contemplated that a thermally sensitive RFID tag can utilize a plurality of different thermally-conductive materials. Further, an RFID tag can utilize at least one thermally-conductive material with superior lateral and longitudinal thermal conductivity and at least one thermally-conductive material with superior vertical thermal conductivity in conjunction at least with any of the embodiments described herein.

While various representative embodiments of improved RFID tags have been illustrated, many general principles disclosed herein are contemplated as being independently employable as well as in all workable permutations and combinations. Further, it should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A radio frequency identification (RFID) tag for sensing a temperature of a surface, the RFID tag comprising:
a flag section including an integrated circuit, the integrated circuit including an RFID transponder and a temperature sensor in communication therewith;
a tail section projecting outwardly from the flag section to an outward end; and
a thermally-conductive material coupled to the tail section, the thermally-conductive material being configured to transfer thermal energy from the outward end of the tail section to the temperature sensor in the integrated circuit in the flag section.

2. The RFID tag of claim 1, wherein the thermally-conductive material extends from the outward end of the tail section to a longitudinal position of the temperature sensor.

3. The RFID tag of claim 2, wherein the thermally-conductive material extends from an outward end of the tail section to a side of the flag section opposite the tail.

4. The RFID tag of claim 3, wherein the RFID transponder includes two antenna arms and wherein the thermally-conductive material includes a notch positioned so that the thermally-conductive material only crosses one of the two antenna arms.

5. The RFID tag of claim 1, wherein the thermally-conductive material is configured to selectively transfer thermal energy from the outward end of the flag section to the temperature sensor.

6. The RFID tag of claim 5, wherein the tail section is selectively foldable from an unfolded position to a folded position and wherein the thermally-conductive material is configured to transfer thermal energy to the temperature sensor when the tail section is in the folded position.

7. The RFID tag of claim 6, wherein the thermally-conductive material includes a portion that is vertically-aligned with the temperature sensor when the tail section is in the folded position and wherein the thermally-conductive material does not include a portion that is vertically-aligned with the temperature sensor when the tail section is in the unfolded position.

8. The RFID tag of claim 1, wherein the flag section and the tail section are integrally-formed.

9. The RFID tag of claim 8, further comprising a top layer and a bottom layer wherein the thermally-conductive material and the RFID transponder are retained in between the top layer and the bottom layer.

10. The RFID tag of claim 9, wherein the temperature sensor is in contact with the thermally-conductive material.

11. The RFID tag of claim 10, wherein the bottom layer is a liner, wherein the liner is detachable from an adhesive to expose the adhesive, and wherein the adhesive is configured to secure the tail section to the surface.

12. The RFID tag of claim 1, wherein the flag section includes an inlay section and a fold-over section and wherein the integrated circuit is included in the inlay section.

13. A strip of radio frequency identification (RFID) temperature sensors comprising:
a plurality of RFID tags, each of RFID tag being configured in accordance with claim 1;
wherein the plurality of RFID tags are integrally formed in a continuous sheet that are detachable from one another.

14. A radio frequency identification (RFID) tag for sensing a temperature of a surface, the RFID tag comprising:
an integrated circuit including an RFID transponder and a temperature sensor in communication therewith;
a thermally-conductive material extending away from the integrated circuit toward an attachment surface, thereby spatially separating the integrated circuit from the attachment surface; and
wherein the thermally-conductive material is configured to transfer thermal energy from the attachment surface toward the temperature sensor in the integrated circuit.

15. The RFID tag of claim 14, wherein the attachment surface of the thermally-conductive material is configured to be selectively secured to the surface.

16. The RFID tag of claim 14, wherein the thermally-conductive material comprises silicone.
